(19) United States
(12) Patent Application Publication
(10) Pub. No.: US 2020/0050301 A1
(43) Pub. Date: Feb. 13, 2020

(54) Coupled Input and Information System

(71) Applicants: Eric Provost, Paris, Orsay (FR); Pen O'Tick, Paris, Orsay (FR)

(72) Inventor: Eric PROVOST, Paris, Orsay (FR)

(21) Appl. No.: 16/605,832

(22) PCT Filed: Apr. 13, 2018
(86) PCT No.: PCT/EP2018/059582

§ 371 Date: Oct. 17, 2019

(30) Foreign Application Priority Data
Apr. 17, 2017 (FR) 17/70393

(51) Int. Cl. G06F 3/041; G06F 3/01; G06F 1/16

(52) U.S. Cl. CPC G06F 3/041; G06F 1/163; G06F 3/011; G06F 3/016

(57) ABSTRACT

The invention provides the user with a means of information via a display and a device for determining areas able to serve for the input of commands, text or elements having a graphic representation. The device has a detection of 8 or 9 areas marked by guides including an optional central guide. The area detection sensor is positioned in the extension of the palm and the display necessary for the input is made within the extension of the bracelet. This device will be particularly suitable for communication devices usable in a pair with other electronic or mechanical products available for the arms of users in order to enable an input of information limiting problems of musculoskeletal disorders.

### CONTEXT

The invention presented is concerned with a touch location sensor and display that can discretise at least between eight and nine distinct available zones.

In general, the means of input available on an arm is essentially limited to mechanical or virtual keyboards on or just within the extension of the casing of the device attached above the arm in the direction of the bracelet up to the edge of the wrist facing the thumb. Usually, it is a watch with calculator features or a smartwatch that has this kind of functionality.

Entry on this type of product is still anecdotal (limited) and difficult, particularly because of the lack of support for our limbs in the same way as typing a text on a real keyboard where our forearms rest on the table. Finally, to be able to perform the input in conjunction with the input being on a screen placed above the wrist necessitates releasing the elbow from the body and working the arm muscles in an uncomfortable way over a long period of time. Beyond the musculoskeletal disorder aspect, quick information entries are more easily made blindly: to enter text quickly on a desktop keyboard, two pins on the letters F and J (on a QWERTY keyboard) allow the user to place their fingers and enter text without looking at the placement of their fingers: there is little or no equivalent system on wrist products.

The device described in this invention makes it possible to remedy to advantage all the problems cited above. The device comprises according to the first characteristic a display to relay the information input and/or the zones determined by the touch location sensor placed in the extension of the support bracelet and above the touch location sensor. Since the touch location sensor is able to locate the presence of a finger on one of the eight or nine zones, the display returns a marking of the corresponding zone at the place covered by the finger: thus, the input of information is possible due to the fact that it is only necessary to translate the ordering of the selections of the zones covered by the finger into the chosen entity.

The touch location sensor is a tactile component with four surfaces, sensitive to the presence of a finger distributed over the entire elliptical crown, which is segmented into four parts, for example, according to the largest and smallest diameter of the ellipse. The separation of the border between the four zones two by two is likely to be drawn unevenly so that at this point the drawing covers a zone equivalent to the contact of a finger, thus making it possible to detect a zone on this separation, seen by the touch location sensor as the simultaneous detection of two segments. Each segment must be large enough to contain the contact of a finger without this contact being seen on the other segments. We therefore recognise eight available segments. The last contact zone is optional and permits the detection of the presence of the finger in the centre of the ellipse, the distance between the edges of the ellipse and this contact zone must be sufficient to allow unambiguous input unless it is considered that as long as a contact on the elliptical crown is observed, one cannot consider the contact in its centre. In fact, the central contact zone must be large enough to contain the touch of a finger without there being a significant influence on an adjacent zone when pointed at by a finger.

To achieve better ergonomics, the proportions of the ellipse must be merged with the comfortable vertical and horizontal excursions of the tip of a thumb on one plane with the rest of the fingertips of the hand in a fixed position when the invention is used on an arm.

In third-party uses of the sensor, when the finger has to be replaced by a sleeve, the zone sizes must be adjusted accordingly.

The realisation of the tactile zones must therefore follow the shape of the elliptical crown but can be realised in practice by a composition of circles, ovals and quadrilaterals inscribed within the elliptical crown and being able to overflow it on the outside.

A pin will be placed in the centre of the central tactile zone or elliptical crown. Each of the touch location sensor's detection zones will be delimited by four pins two by two delimiting for the adjacent zones.

A pin can range in size from 0.5 mm to 3 mm in diameter and 0.5 mm to 2 mm in thickness.

The distance between the edges of the elliptical crown and the central tactile zone may be from one hundredth of a millimetre to 10 centimetres or more to correspond to the size of the stimulating element in contact with one tactile surface or a plurality of tactile surfaces used to cover this distance.

Optionally the displayable surface can be placed under the touch location sensor then transparent.

Generally speaking, the display can extend within the extension of the bracelet towards the top of the wrist until it turns around.

The touch location sensor uses electronic or perhaps computer-based means to perform its function as determined in the patent.

The invention may also include one or more of the following characteristics, considered individually, or in all technically possible combinations:
The coupled information and input device is characterised in that it comprises a touch location sensor and a display placed side by side, the display being an extension of the touch location sensor, and displaying, in whole or in part, the locations determined by the touch location sensor.
The device is characterised in that the touch location sensor can be transparent, in this case the foot of the display can be placed or extended in front of the touch location sensor so that the display is partially or completely under the touch location sensor.
The device is characterised in that the touch location sensor can be placed on or in a bracelet at the forearm and to the side of the palm of the hand; the display extends in the direction of the bracelet and displays the contact locations returned or determined by the touch location sensor from a common edge with the display of the touch location sensor, or the edge of the display under the touch location sensor, up to and including the edge of the wrist within the extension of the thumb.
The coupled information and input device is characterised in that it includes a touch location sensor comprising at least eight tactile zones; eight tactile zones are arranged on an elliptical crown, segmented radially into eight, and a tactile zone will be assigned by segment to the elliptical crown.
The device is characterised in that the contact location sensor comprises in a non-restrictive manner four distinct tactile surfaces each conforming to the shape of a segment of an elliptical crown constituted by the division of the elliptical crown into four by radial laces or divisions separated by 90 degrees from each other in the same way in which each surface is formed in the absence of following the shape of the elliptical crown by a composition of zero, one or a plurality of rounds, ovals and quadrilaterals inscribed in the elliptical crown and capable of spilling over to the exterior of the elliptical crown; the separation between two distinct and adjacent surfaces at the level of the laces or radial divisions of the elliptical crown, whether curved or straight or a composition of curves or straight lines, must be total; then the touch location sensor will locate a touch through a tactile surface in contact only with a stimulating element in contact with a tactile surface or a plurality of tactile surfaces and a contact for two adjacent tactile surfaces on the elliptical crown and in simultaneous contact with a stimulating element in contact with a tactile surface or a plurality of tactile surfaces; being the eight tactile zones returned or determined by the touch location sensor via the contact with a stimulating element in contact with a tactile surface or a plurality of tactile surfaces.
The device is characterised in that the touch location sensor contains an optional central touch zone placed inside the elliptical crown and separated from the elliptical crown.
The device is characterised in that the touch location sensor contains an optional central touch zone placed inside the elliptical crown and separated from the elliptical crown; the touch location sensor returns or determines that the central tactile zone is in contact with a stimulating element in contact with a tactile surface or a plurality of tactile surfaces only when it is the only one to be in contact with the stimulating element in contact with a tactile surface or a plurality of tactile surfaces, otherwise the returned or determined contacts are those returned or determined regardless of the existence of the central tactile zone.
The device is characterised in that the contact returned or determined in the event of simultaneous multiple touches of a touch zone or touch zones on the elliptical crown and the central touch zone with a stimulating element in contact with a touch surface or a plurality of touch surfaces is unchanged as long as this situation persists.
The device is characterised in that the centre of the location sensor has a pin that is discernible to the touch or that can be felt under a finger.
The device is characterised in that the internal periphery of the elliptical crown has eight pins discernible to the touch or that can be felt under a finger and placed at the eight separations of the segments of the elliptical crown.
The device is characterised in that the external periphery of the elliptical crown has eight pins discernible to the touch or that can be felt under a finger and placed at the eight separations of the segments of the elliptical crown.

The invention is not limited to the particular modes of realisation that have been described above; many variants can be designed.

### DESCRIPTION OF THE ILLUSTRATIONS

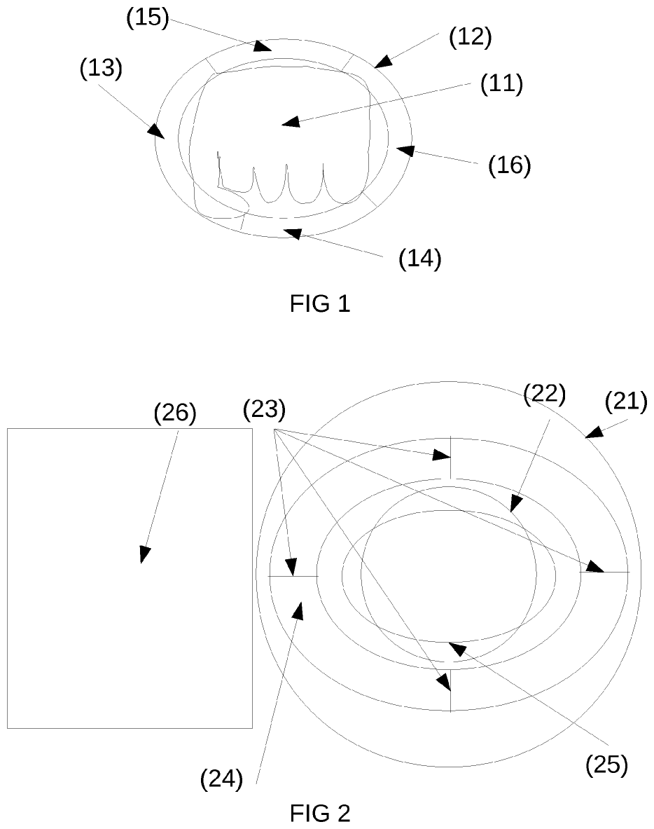

FIG. 1: Example of the device placed around an arm

FIG. 2: Example of tactile zones of the touch location sensor

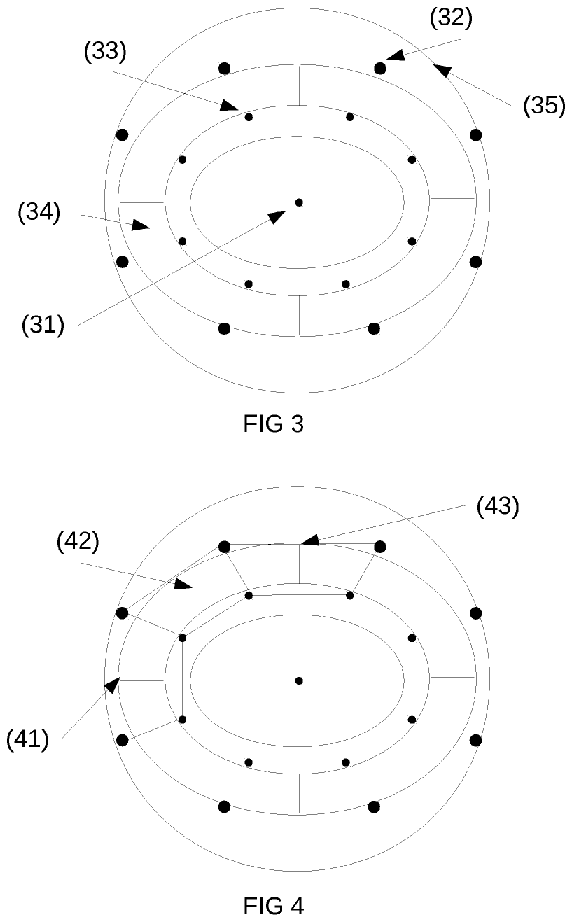

FIG. 3: Example of pin distribution on the touch location sensor

FIG. 4: Example of touch zone distribution on the touch location sensor

### DESCRIPTION OF AN EXAMPLE

With reference to the drawings, the device fits into a FIG. 1 (12) bracelet around a left arm (11), the hand closed in a first being seen from the front. The touch location sensor is placed on the arm on the palm side (14) and the display required to perform the input is located in the extension of the bracelet above the contact location sensor (13). Any instrument can then be positioned in the extension of the back of the hand on the bracelet (15), and the last zone of the bracelet (16) contains the clasp.

The touch location sensor is like locating a touch from a finger, ideally a thumb, on zones arranged in an ellipse FIG. 2, i.e. an elliptical crown (24) segmented into four zones with no contact between them by four boundaries (23). The elliptical crown is increased by two circles (21) and (22). A central zone (25) is far enough away from the edges of the elliptical crown but also large enough to be sensitive to the passage of a finger. Finally, the orientation of the elliptical crown corresponds to the possible amplitude from top to bottom and right to left of the thumb of the opposite hand to that of the arm carrying the touch location sensor and display and placed on the hand which is within the extension of the touch location sensor; the display screen (26) being within the extension of the touch location sensor on the bracelet towards the top.

The contact location sensor has seventeen pins identifiable by touch FIG. 3, the first one is in the centre of the sensor (31), and the other sixteen are distributed half (32) on the external ellipse of the elliptical crown and the other half (33) on the internal ellipse of the elliptical crown. These pins are positioned to delimit the eight zones on the elliptical crown FIG. 4 in the form of quadrilaterals (41) (42) and (43).

The invention is not limited to the particular modes of realisation described above, as many variants can be designed without exceeding the scope defined by the attached claims.

The invention adapts appropriately to an arm input system by allowing ergonomic input with the arm supporting the device able to be positioned alongside the body and against the body at belly or chest level and the other arm alongside the body with the hand on the hand of the arm supporting the location sensor so as to provide natural support to the limbs during input.

1-11. (canceled)

12. A coupled information and input device, comprising:
a contact location sensor comprising:
at least eight tactile zones, wherein the at least eight tactile zones are arranged on an elliptical crown segmented radially into eight, and wherein one tactile zone will be assigned to each segment on the elliptical crown characterised in that the touch location sensor is placed on or in a bracelet at the forearm and at the palm side of the hand; and
a central tactile zone is placed at the centre of the elliptical crown, and the internal periphery of the elliptical crown has eight pins discernible to the touch or that can be felt under a finger and placed at the eight separations of the segments of the elliptical crown.

13. The device according to claim 12 wherein the centre of the location sensor has a pin that is discernible to the touch or that can be felt under a finger.

14. The device according to claim 12 wherein the external periphery of the elliptical crown has eight pins that are discernible to the touch or that can be felt under a finger and placed at the eight separations of the segments of the elliptical crown.

15. The device according to claim 12 wherein the display extends in the direction of the bracelet and displays the contact locations returned or determined by the touch location sensor from a common edge with the display of the touch location up to and including the edge of the wrist within the extension of the thumb.
